(19) United States
(12) Patent Application Publication
(10) Pub. No.: US 2026/0056015 A1
(43) Pub. Date: Feb. 26, 2026

(54) METHOD TO LOCATE FIBER OPTIC CABLE ON THE SEA FLOOR IN A TRANSITION ZONE

(71) Applicant: Schlumberger Technology Corporation, Sugar Land, TX (US)

(72) Inventors: Pierre Bettinelli, Le Puget Sur Argens (FR); Joel Herve Le Calvez, Sugar Land, TX (US); Nicholas Fundytus, Edmonton (CA); Peter MacLeod, Aberdeen (GB); Yinn Hoong Tan, Kuala Lumpur (MY)

(21) Appl. No.: 18/812,323

(22) Filed: Aug. 22, 2024

(51) Int. Cl. G01C 13/00; G02B 6/50

(52) U.S. Cl. CPC G01C 13/008; G02B 6/506

(57) ABSTRACT

Embodiments presented provide for a method for locating or placing fiber optic cable on a sea floor. The placement of the fiber optic cable may be performed in a transition zone that typically causes errors in conventional placement technologies.

### CROSS-REFERENCE TO RELATED APPLICATIONS

None.

### FIELD OF THE DISCLOSURE

Aspects of the disclosure relate to measurements performed in geological studies in hydrocarbon recovery projects. More specifically, aspects of the disclosure relate to a method to locate fiber optic cable accurately on a sea floor in geological transition zones.

### BACKGROUND

In seismic formation characterization, geoscientists and engineers aim to understand the elastic and viscoelastic properties of formations. A key motivation for conducting surface seismic surveys is to visualize underground formations and compare them with borehole seismic surveys, which offer precise time-depth relationships that aid in adjusting the depth of surface seismic imaging. Often, little to no borehole seismic surveys are present. There is still a need; however, for accurate characterization of geological features.

Distributed acoustic sensing is a cost-effective and readily deployable technology. By placing or lightly burying a fiber optic cable on the ground or seafloor, either on land or at sea (transition zone to deep ocean), it enables, to an extent, high-density seismic data collection for analyzing both near-surface and deeper geological features with the recorded waveforms (like body waves, surface waves, etc.).

A U-shape pattern is often used for laying single mode fiber optic cables (see FIG. 1) to optimize the coverage of the target area and enhance the depth of investigation while reducing the need for multiple acquisition units or recorders. Ideally, these recorders stay on dry land to facilitate power access and data retrieval. Offshore, the fiber optic cable may be buried in trenches or remained to lay on the seafloor.

It is not uncommon to not know with sufficient accuracy where the fiber optic cable lays due to poor anchoring, maritime currents, etc. Yet, knowing with great accuracy where the cable is located on the seafloor is critical to maintain its integrity when various activities occur and could damage said cable.

There is a need to accurately locate a fiber optic cable (C) to ensure the cable's integrity is maintained.

There is a further need to locate the fiber optic cable so that communication with the cable is not interrupted by various factors, including the ultimate placement of the cable on the sea floor.

There is a further need to provide for fiber optic cable to be placed in an aquatic environment such that the data obtained by and through the cable is accurate for engineers and scientists.

There is a further need to provide an apparatus and methods that are easy to operate and perform such that cable placement is readily achieved by field personnel.

There is a further need to provide apparatus and methods that do not have the drawbacks discussed above, namely, inaccurate readings from equipment as well as inaccurate placement of cable.

There is a still further need to reduce economic costs associated with operations and apparatus described above with conventional tools in placement of optic cable.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for determining a position of a fiber optic cable in a transition zone is disclosed. The method may comprise traversing a source over an area in the transition zone that contains a fiber optic cable. The method may further comprise recording a position of the source during the traversing of the source of the area in the transition zone. The method may further comprise sending a signal from the source into an aqueous environment while simultaneously recording a start time for the sending of the signal. The method may further comprise receiving the signal from the source into the fiber optic cable. The method may further comprise transmitting the signal through the fiber optic cable to a recording station. The method may further comprise recording the signal at the recording station while also identifying a recording time. The method may further comprise continuing steps of recording the position of the source, sending a signal from the source into the aqueous environment, receiving the signal, transmitting the signal, and recording the signal at the recording station while also identifying the recording time. The method may further comprise computing a time of flight for each signal transmitted from the source. The method may further comprise identifying a minimum value for the times of flight computed. The method may further comprise identifying the position for the time of flight corresponding to the minimum value as the position for the fiber optic cable.

In another example embodiment, a method for determining a position of a fiber optic cable in a transition zone and imaging the transition zone is disclosed. The method may comprise traversing a vibration source in the transition zone that contains a buried fiber optic cable. The method may further comprise recording a position of the source during the traversing of the source of the area in the transition zone. The method may further comprise sending a signal from the source into an aqueous environment while simultaneously recording a start time for the sending of the signal. The method may further comprise determining an aqueous depth of a sea floor at the same time of sending the signal from the source into the aqueous environment. The method may further comprise receiving the signal from the source into the fiber optic cable. The method may further comprise transmitting the signal through the fiber optic cable to a recording station. The method may further comprise recording the signal at the recording station while also identifying a recording time. The method may further comprise continuing steps of recording the position of the source, sending a signal from the source into the aqueous environment, determining the aqueous depth of the sea floor, receiving the signal, transmitting the signal, and recording the signal at the recording station while also identifying the recording time. The method may further comprise computing a time of flight for each signal transmitted from the source. The method may further comprise identifying a minimum value for the times of flight computed. The method may further comprise identifying the position for the time of flight corresponding to the minimum value as the position for the fiber optic cable. The method may further comprise using the aqueous depth, identifying a soil profile, and a depth for burial for the buried fiber optic cable

In another example embodiment, a method for determining a temperature and depth relationship in a transition zone is determined. The method may comprise traversing a source in the transition zone that contains a fiber optic cable while simultaneously recording a position of the source. The method may further comprise generating a signal from the source into an aqueous environment while simultaneously recording a start time for the generation of the signal as well as using a depth finder to determine an aqueous depth. The method may further comprise receiving the signal from the source into the cable. The method may further comprise transmitting the signal to a recording station. The method may further comprise recording the signal and a recording time at the recording station. The method may further comprise continuing steps of; traversing, generating, receiving, transmitting, and recording for differing signals generated. The method may further comprise computing a time of flight for each signal transmitted from the source. The method may further comprise determining a minimum time of flight for all of the signals. The method may further comprise determining individual sectional times of flight for the time of flight for the pathway of the signal traversing from the source to the recording station. The method may further comprise matching the sectional time of flight for the aqueous environment to a defined temperature profile to determine the temperature of the aqueous environment and location of the receiver.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not to be considered limiting of its scope, for the disclosure may admit to other equally effective embodiments.

FIG. 1 is a schematic representation of a fiber optic layout in a geological transition zone.

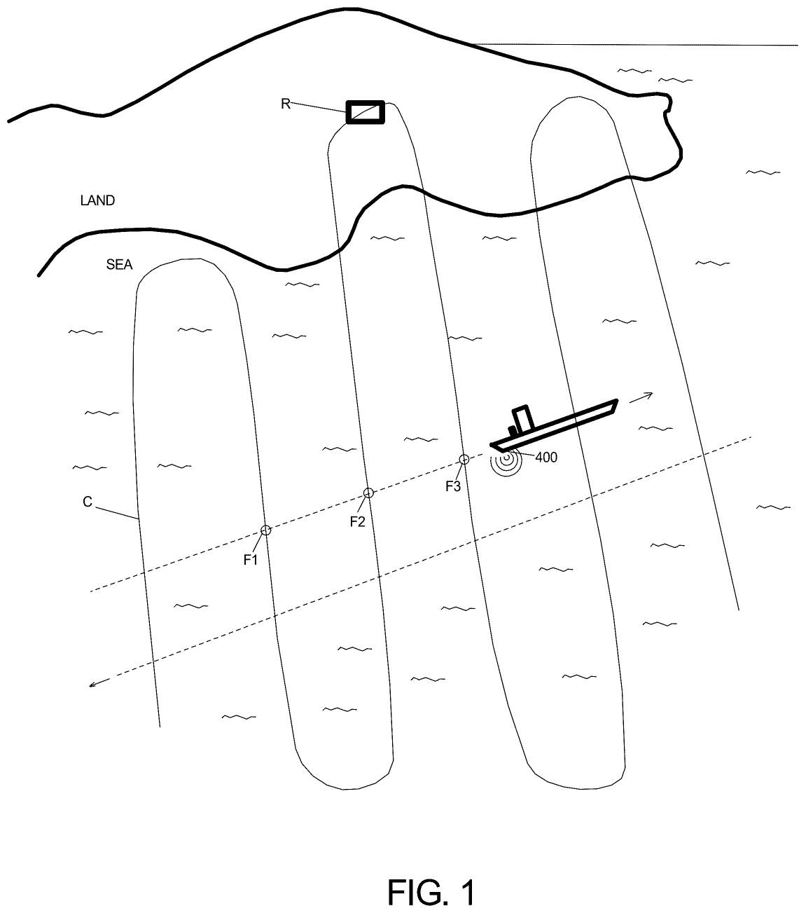

FIG. 2 is a view of the use of transit time to locate a fiber optic cable in one example embodiment of the disclosure.

FIG. 3 is a method for locating a fiber optic cable in one example embodiment of the disclosure.

FIG. 4 is a cross-section of an aqueous environment showing a signal generating source as fiber optic cable placed upon the sea floor.

FIG. 5 is a description of time of flight showing the discrete steps for time elapsing from signal generation to recordation.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to”, another element or layer, it may be directly on, engaged, connected, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide a method to locate fiber optic cable. In one example embodiment, the fiber optic cable is laid upon the seafloor. Although described as being laid upon the seafloor, fiber optic cable may be slightly buried in the geological strata at the service of the seafloor. In embodiments, fiber optic cable is positioned in a wavelike configuration extending from the shoreline out to sea. Placement of the fiber optic cable may be performed in a transition zone from a beach or non-marine environment out to deep water. As will be understood, the amount of distance between the shoreline and the water can vary; therefore, the amount of a transition zone may be from a kilometer from the shoreline up to many kilometers from the shoreline.

As will be understood, the fiber optic cable is configured to receive a signal sent from the source and transmit that signal back on shore to a monitoring station. In embodiments, the monitoring station may be directly adjacent to the shoreline or may be extended out from the shoreline. A source, as defined herein, provides energy into the environment such that the energy transfers through a water/aqueous environment to the fiber optic cable placed upon the seafloor. The source may generate sound waves or vibration waves, in nonlimiting embodiments. These signals enter the fiber optic cables based on seafloor and are transmitted down the axis of the fiber optic cable to the monitoring station.

As will be understood, the source may be varied in position over time such that, at times, the source may be further away from a portion of the fiber optic cable and then at a later point, the source may be in a location that is closer to the fiber optic cable. Signals are generated from the source, careful records are maintained such that the position of the source through a global positioning satellite or other means are used to accurately locate the source in X, Y a grid within the transition zone. As the source moves, signals are continually generated and intercepted by the fiber optic cable, thus being transmitted back to the recording station-R. Since the distance between the source and the fiber optic cable changes, the amount of time of flight of the signals going from the source to the recording station-R will vary. This variation can be plotted as the source traverses the transition zone. For example, the amount of time that is expended from signal generation until the signal is received at the recording station-R can be determined for each signal generation and therefore, it can be determined from such data where a minimum value of time-of-flight occurs. At this minimum value, the source is closest to the fiber optic cable placed on the seafloor. As result, the data pertaining to the positioning of the source directly above fiber optic cable occurs when the minimum time-of-flight is recorded. The source may be moved along the shoreline or throughout the transition zone and other portions of fiber optic cable may be identified in a similar fashion. In this manner, many different portions of the fiber optic cable may be identified through multiple passes of the source overtop of the fiber optic cable throughout the transition zone.

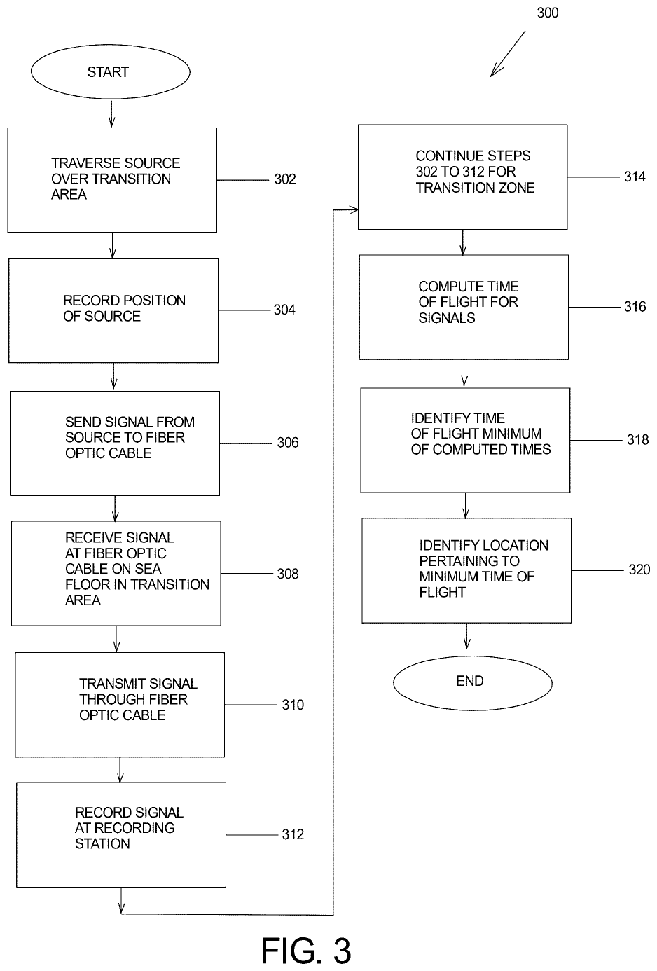

Referring to FIG. 3, a method 300 for determination of a position of a fiber optic cable in a transition zone is illustrated. The method 300 may comprise, at 302, traversing a source over an area that contains a fiber optic cable. The method may also comprise, at 304, recording a position of the source as the source traverses over the area. The method may further comprise, at 306, sending a signal from the source into an aqueous environment while simultaneously recording a start time for the signal. The method may further comprise, at 308, receiving the signal from the source into the fiber optic cable. The method may further comprise, at 310, transmitting the signal through the fiber optic cable to a recording station. The method may further comprise, at 312, recording the signal at the recording station, wherein the recording station identifies a recording time. The method further comprises, at 314, continuing steps of the traversing the source over the area that contains the fiber optic cable, recording the position of the source as the source traverses over the area, sending a signal from the source into an aqueous environment while simultaneously recording a start time for the signal, receiving the first signal from the source into the fiber optic cable, transmitting the signal through the fiber optic cable to the recording station and recording the signal at the recording station, wherein the recording station identifies the recording time over a series of time. The method may further comprise, at 316, computing a time of flight for each signal transmitted from the source. The method may also comprise, at 318, identifying a minimum value of the times of flight. The method may also comprise, at 320, identifying a position in the area corresponding to the minimum value of the time of flight.

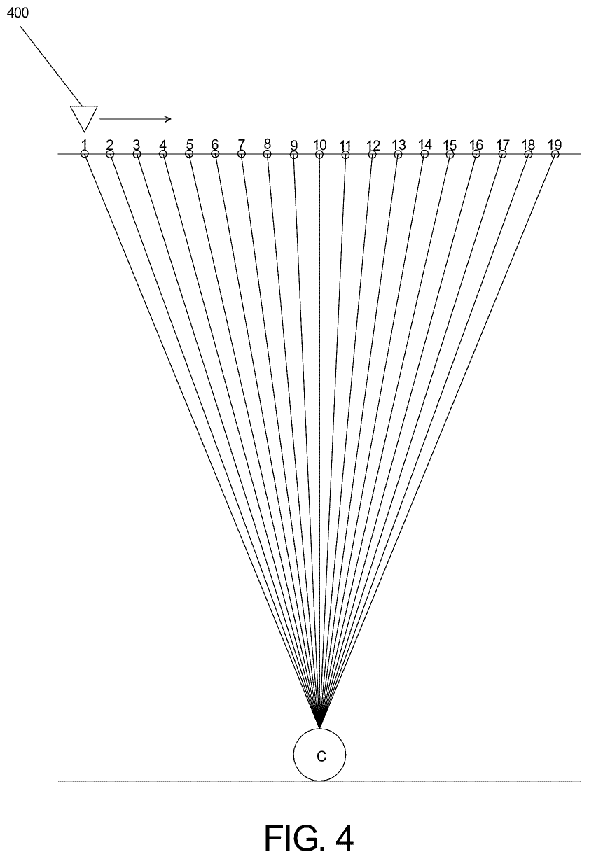

Referring to FIG. 4, a cross-section of a source 400 moving over a fiber optic cable-C is illustrated. In the illustrated embodiment, the source 400 is traveling from the left side to the right side. Generally, the speed of the source 400 is kept constant, though such constant velocity is not a requirement. During the traveling of the source 400, an accurate location of the source along its path and the time passing is kept. Each of the numbers 1 through 19, illustrate a different location where the source 400 is activated. As can be seen by FIG. 4, the distance between each location 1 through 19 and the fiber optic cable-C is different. As the distance differences between the source 400 and the fiber optic cable-C are different and the speed of the waves generated by the source 400 are constant, the amount of time it takes to travel each distance shown varies. As can be seen, location 10 has the least amount of distance to be covered, therefore the amount of time that it takes for the waves generated by the source 400 to traverse this distance will be the least. By accurate record keeping between the source 400 and the recording location located on land, the each of the total times of flight of the signals generated by the source 400 can be recorded and compared. The minimum time of flight indicates a location that is closest between the source 400 and the fiber optic cable-C.

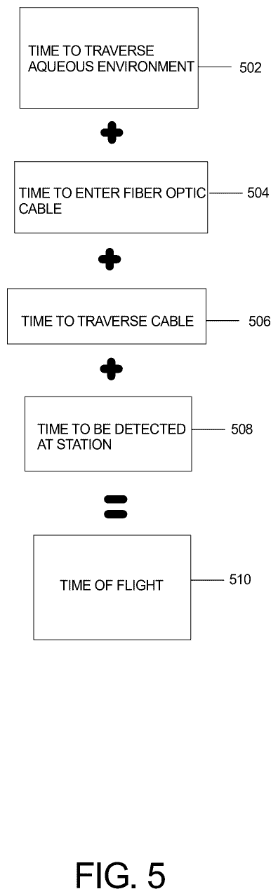

Referring to FIG. 5, the individual pathways that a signal takes from generation to recordation in embodiments of the disclosure is illustrated. The first pathway traversed is the time to traverse the aqueous environment at 502. The second pathway traversed is the time for the signal to enter the fiber optic cable at 504. The third pathway traversed is the time to traverse the cable from the point of entry of the fiber optic cable to transmission to the detection station at 506. The fourth pathway traversed is the time to be detected at the station up entering at 508. The total of each one of the pathways determines the time of flight for the signal. As can be understood, the values of 504, 506 and 508 will be essentially equivalent for each case. Variations in the overall time is therefore related to 502, the time to traverse the aqueous environment. As the velocity of the signals sent by the source are of a constant velocity, the distance to the cable can easily be determined once the overall time is known.

In embodiments, the depth of the fiber optic cable-C can vary not only according to the overall depth of the aqueous environment but also the depth at which the fiber optic cable-C is buried within a geological stratum. In some embodiments, a depth finder can be used in conjunction with the source. The depth finder can find the bottom of the sea floor and correlations may be performed such that data pertaining to the depth of the buried fiber optic cable-C may be made. According to the depth of the buried fiber optic cable, further data may be obtained about the type of material surrounding the fiber optic cable. For example, it may be known through extensive tests, that certain types of sandy soils transmit signals at various frequencies and speeds. If, through the study of the data, it can be found that the frequencies and speeds of transmission are similar to those found experimentally for sand, it can be logically determined that the soils surrounding the fiber optic cable-C are sandy in nature.

In embodiments, a log of different type of soils and their transmission speeds may be kept by field personnel. Upon analysis of the data, it may be determined that portions of the fiber optic cable-C may be buried in sand, and then other portions buried in a silt/clay mixture. To this end, not only the depth of the fiber optic cable-C may be determined, but also information related to accurate imaging of the transition zone. Such information is important as these transition zones have significant mixing and potential for variation.

The measurements performed by the methods described produce accurate results. Other features of the environment may also be determined through the method described. The method may be used to determine relationships to temperatures encountered and features such as depth of the fiber optic cable-C. For example, it may be determined that temperatures affect the transmissibility of not only the aqueous medium but also the geological stratum. To this end, laboratory testing may predetermine that different temperatures allow for faster or slower transmission of signals. If, in some instances, a depth finder is used in conjunction with the source and the overall depth of the aqueous environment is accurately recorded, the data may be back calculated to determine the average temperature of the aqueous environment corresponding to the time of flight and individual pathways traversed by the signals.

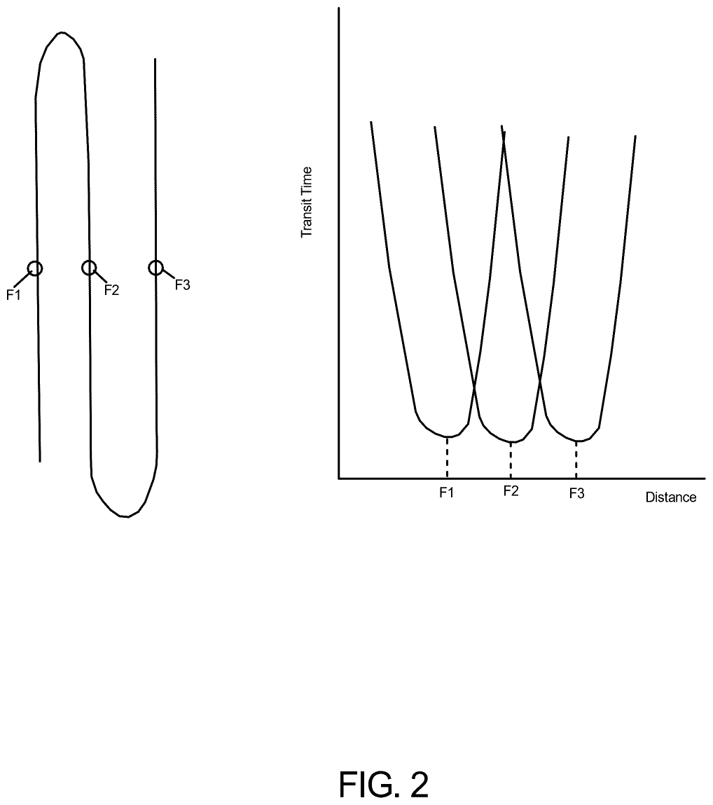

As illustrated in FIG. 2, the left-most portion of the FIG. illustrates a fiber optic cable-C in plan view. In the right-most portion of FIG. 2, a plot of transit time (y axis) vs. distance is illustrated. The minimum values for transmit time correspond to the location of the fiber optic cable-C.

Example embodiments of the claims are described next. The following recitation should not be considered as limiting the disclosure. In one example embodiment, a method for determining a position of a fiber optic cable in a transition zone is disclosed. The method may comprise traversing a source over an area in the transition zone that contains a fiber optic cable. The method may further comprise recording a position of the source during the traversing of the source of the area in the transition zone. The method may further comprise sending a signal from the source into an aqueous environment while simultaneously recording a start time for the sending of the signal. The method may further comprise receiving the signal from the source into the fiber optic cable. The method may further comprise transmitting the signal through the fiber optic cable to a recording station. The method may further comprise recording the signal at the recording station while also identifying a recording time. The method may further comprise continuing steps of recording the position of the source, sending a signal from the source into the aqueous environment, receiving the signal, transmitting the signal, and recording the signal at the recording station while also identifying the recording time. The method may further comprise computing a time of flight for each signal transmitted from the source. The method may further comprise identifying a minimum value for the times of flight computed. The method may further comprise identifying the position for the time of flight corresponding to the minimum value as the position for the fiber optic cable.

In another example embodiment, the method may be performed wherein the source is located upon a boat in the transition zone.

In another example embodiment, the method may be performed wherein the fiber optic cable is at least partially buried in the transition zone.

In another example embodiment, the method may be performed wherein the recording of the position of the source is performed through a global positioning system.

In another example embodiment, the method may be performed wherein the recording station is located in an on-shore position.

In another example embodiment, the method may be performed wherein the signal is vibrational waves.

In another example embodiment, the method may be performed wherein the signal has a defined periodicity and frequency.

In another example embodiment, a method for determining a position of a fiber optic cable in a transition zone and imaging the transition zone is disclosed. The method may comprise traversing a vibration source in the transition zone that contains a buried fiber optic cable. The method may further comprise recording a position of the source during the traversing of the source of the area in the transition zone. The method may further comprise sending a signal from the source into an aqueous environment while simultaneously recording a start time for the sending of the signal. The method may further comprise determining an aqueous depth of a sea floor at the same time of sending the signal from the source into the aqueous environment. The method may further comprise receiving the signal from the source into the fiber optic cable. The method may further comprise transmitting the signal through the fiber optic cable to a recording station. The method may further comprise recording the signal at the recording station while also identifying a recording time. The method may further comprise continuing steps of recording the position of the source, sending a signal from the source into the aqueous environment, determining the aqueous depth of the sea floor, receiving the signal, transmitting the signal, and recording the signal at the recording station while also identifying the recording time. The method may further comprise computing a time of flight for each signal transmitted from the source. The method may further comprise identifying a minimum value for the times of flight computed. The method may further comprise identifying the position for the time of flight corresponding to the minimum value as the position for the fiber optic cable. The method may further comprise using the aqueous depth, identifying a soil profile, and a depth for burial for the buried fiber optic cable The method may also be performed wherein the determining the aqueous depth of the sea floor is through use of a depth finder.

The method may also be performed wherein laboratory tests of various soils are used to compare times of flight to determine the soil profile.

The method may also be performed wherein the signal is vibrational waves.

The method may also be performed wherein the signal has a defined periodicity and frequency.

In another example embodiment, a method for determining a temperature and depth relationship in a transition zone is determined. The method may comprise traversing a source in the transition zone that contains a fiber optic cable while simultaneously recording a position of the source. The method may further comprise generating a signal from the source into an aqueous environment while simultaneously recording a start time for the generation of the signal as well as using a depth finder to determine an aqueous depth. The method may further comprise receiving the signal from the source into the cable. The method may further comprise transmitting the signal to a recording station. The method may further comprise recording the signal and a recording time at the recording station. The method may further comprise continuing steps of; traversing, generating, receiving, transmitting, and recording for differing signals generated. The method may further comprise computing a time of flight for each signal transmitted from the source. The method may further comprise determining a minimum time of flight for all of the signals. The method may further comprise determining individual sectional times of flight for the time of flight for the pathway of the signal traversing from the source to the recording station. The method may further comprise matching the sectional time of flight for the aqueous environment to a defined temperature profile to determine the temperature of the aqueous environment and location of the receiver.

In another example embodiment, the method may be performed wherein the transition zone is an aqueous brine environment with a depth of less than 2 kilometers.

In another example embodiment, the method may be performed wherein the individual sectional times include at least one of a distance between the fiber optic cable and the recording station, and a distance between the source and the receiver.

Embodiments of the disclosure may provide for an article of manufacture that contains a non-transitory memory product. The non-transitory memory product may be configured to retain data, such as method steps. The non-transitory memory product may store data and be read by a device. Such devices may be computing devices such as a laptop computer, main frame computer, computer cell phone or other similar device. The method steps may be used, for example, to control a computer or perform mathematical calculations. In turn, the computer may instruct other systems, machines or components. Example non-transitory memory products may include universal serial bus devices, solid state memory arrangements, compact discs or computer hard drives. In some instances, the non-transitory device may be configured with a device that reads the stored information and transmits the data to a separate location. In some embodiments, artificial intelligence may be used in conjunction with the data stored on the article of manufacture to perform various functions.

Further embodiments may include methodologies that allow computers to be trained to allow for more comprehensive and accurate answers. Such training may be performed in nodes that may be used to allow for fine tuning of results. Upon retention of results of calculations, the method steps may be altered such that results that are not accurate are precluded from future calculations by amending method steps accomplished in various nodes. Such alterations are contemplated and are within the scope of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for determining a position of a fiber optic cable in a transition zone, comprising:
traversing a source over an area in the transition zone that contains a fiber optic cable;
recording a position of the source during the traversing of the source of the area in the transition zone;
sending a signal from the source into an aqueous environment while simultaneously recording a start time for the sending of the signal;
receiving the signal from the source into the fiber optic cable;
transmitting the signal through the fiber optic cable to a recording station;
recording the signal at the recording station while also identifying a recording time;
continuing steps of recording the position of the source, sending a signal from the source into the aqueous environment, receiving the signal, transmitting the signal, and recording the signal at the recording station while also identifying the recording time;
computing a time of flight for each signal transmitted from the source;
identifying a minimum value for the times of flight computed; and
identifying the position for the time of flight corresponding to the minimum value as the position for the fiber optic cable.

2. The method according to claim 1, wherein the source is located upon a boat in the transition zone.

3. The method according to claim 1, wherein the fiber optic cable is at least partially buried in the transition zone.

4. The method according to claim 1, wherein the recording of the position of the source is performed through a global positioning system.

5. The method according to claim 1, wherein the recording station is located in an on-shore position.

6. The method according to claim 1, wherein the signal is vibrational waves.

7. The method according to claim 6, wherein the signal has a defined periodicity and frequency.

8. A method for determining a position of a fiber optic cable in a transition zone and imaging the transition zone, comprising:
traversing a vibration source in the transition zone that contains a buried fiber optic cable;
recording a position of the source during the traversing of the source of the area in the transition zone;
sending a signal from the source into an aqueous environment while simultaneously recording a start time for the sending of the signal;
determining an aqueous depth of a sea floor at the same time of sending the signal from the source into the aqueous environment;
receiving the signal from the source into the fiber optic cable;
transmitting the signal through the fiber optic cable to a recording station;
recording the signal at the recording station while also identifying a recording time;
continuing steps of recording the position of the source, sending a signal from the source into the aqueous environment, determining the aqueous depth of the sea floor, receiving the signal, transmitting the signal, and recording the signal at the recording station while also identifying the recording time;
computing a time of flight for each signal transmitted from the source;
identifying a minimum value for the times of flight computed;
identifying the position for the time of flight corresponding to the minimum value as the position for the fiber optic cable; and
using the aqueous depth, identifying a soil profile, and a depth for burial for the buried fiber optic cable.

9. The method according to claim 8, wherein the determining the aqueous depth of the sea floor is through use of a depth finder.

10. The method according to claim 8, wherein laboratory tests of various soils are used to compare times of flight to determine the soil profile.

11. The method according to claim 8, wherein the signal is vibrational waves.

12. The method according to claim 11, wherein the signal has a defined periodicity and frequency.

13. A method for determining a temperature and depth relationship in a transition zone, comprising:
traversing a source in the transition zone that contains a fiber optic cable while simultaneously recording a position of the source;
generating a signal from the source into an aqueous environment while simultaneously recording a start time for the generation of the signal as well as using a depth finder to determine an aqueous depth;
receiving the signal from the source into the cable;
transmitting the signal to a recording station;
recording the signal and a recording time at the recording station;
continuing steps of; traversing, generating, receiving, transmitting, and recording for differing signals generated;
computing a time of flight for each signal transmitted from the source;
determining a minimum time of flight for all of the signals;
determining individual sectional times of flight for the time of flight for the pathway of the signal traversing from the source to the recording station; and
matching the sectional time of flight for the aqueous environment to a defined temperature profile to determine the temperature of the aqueous environment and location of the receiver.

14. The method according to claim 13, wherein the transition zone is an aqueous brine environment with a depth of less than 2 kilometers.

15. The method according to claim 13, wherein the individual sectional times include at least one of a distance between the fiber optic cable and the recording station, and a distance between the source and the receiver.
